(19) United States
(12) Patent Application Publication
(10) Pub. No.: US 2015/0296745 A1
(43) Pub. Date: Oct. 22, 2015

(54) MUTT MITTEN

(71) Applicant: Joseph M. Fridlin, Wildwood, MO (US)

(72) Inventor: Joseph M. Fridlin, Wildwood, MO (US)

(21) Appl. No.: 14/755,593

(22) Filed: Jun. 30, 2015

Related U.S. Application Data
(63) Continuation-in-part of application No. 14/143,066, filed on Dec. 30, 2013.

(51) Int. Cl. A01K 13/00; A01K 29/00; A47L 13/18

(52) U.S. Cl. CPC A01K 13/001; A47L 13/18; A01K 29/00

(57) ABSTRACT

The field of the invention relates to a cleaning device, particularly to a reversible, wet and dry cleaning device, specifically designed to facilitate the cleaning of a soiled area. The cleaning device contains an outer wet towel layer and a reversible inner dry towel layer. The outer wet towel layer and inner dry towel layer are separated by a plastic layer.

### CROSS-REFERENCE TO RELATED APPLICATIONS

This Continuation-in-part application claims the benefit of U.S. Non-provisional patent application No. 14/143,066, filed Dec. 30, 2013, which is hereby incorporated by reference in its entirety.

### BACKGROUND OF THE INVENTION

The field of the invention relates to a cleaning device, more particularly to a reversible, wet and dry cleaning device, specifically designed to facilitate the cleaning of a soiled area.

The cleaning of house pets, notably dogs, is known to be an undesirable and messy task after outdoor play. Pet owners must clean soiled paws and fur so carpet and home furnishings will not get dirty. The typical procedure when cleaning soiled animals is to use a damp towel cloth first, followed by the use of a dry towel cloth to wipe away excess moisture. These towel cloths typically will need to be laundered, and dirt, leaves, and feces uncollected by these towel cloths have to be vacuumed or swept away. Therefore, conventional methods of cleaning house pets after outdoor play requires the use of multiple cleaning devices, and it is practically impossible for the user cleaning their pet to not have their hands become soiled in this manner

Although the structure of the present invention is designed to be used for cleaning soiled house pets after outdoor play, it is considered within the scope of this invention that the device could be used with any procedure involved in cleaning a soiled area (for example, a child's face) requiring a reversible, wet and dry cleaning device.

### SUMMARY OF THE INVENTION

The invention relates to a cleaning device, more particularly a reversible, wet and dry cleaning device, specifically designed to facilitate the cleaning of a soiled area. The cleaning device contains an outer wet towel layer and a reversible inner dry towel layer. The outer wet towel layer and inner dry towel layer are separated by a plastic layer.

In an embodiment of the invention, a cleaning device is manufactured in a manner to facilitate the cleaning of house pets after outdoor play which comprises a wet and dry towel layer in a single cleaning device which is reversible.

In another embodiment of this invention, the reversible wet and dry cleaning device is used for all practical cleaning purposes contained herein, particularly to eliminate the transfer of any bacteria and/or contaminants to the user's skin from a soiled surface.

In this previous embodiment the soiled surface area may be a child's face or hands, soiled fur or paws from a house pet, bathroom fixtures (for example, toilets, sinks, and showers), and kitchen appliances.

In yet another embodiment, the wet towel layer may be pre-soaked and saturated with a liquid cleaning solution, such as a disinfectant.

According to another embodiment of the invention, the outer wet layer may be adapted for scrubbing a soiled surface.

In another embodiment of the invention, the outer wet layer made be made of a gauze pad or other materials which have adsorbent properties and facilitate the cleaning of a soiled surface.

In yet another embodiment, the invention describes a reversible cleaning device for cleaning a soiled area wherein the reversible cleaning device comprises a wet outer towel layer and a dry inner towel layer separated by a plastic barrier layer.

In another embodiment, he reversible cleaning device as described herein compromises a wet outer towel layer, the dry inner towel layer, and plastic barrier layer are thermally bonded to each other. This reversible cleaning device as described an access opening for a user's hand at the bottom end of said reversible cleaning device. The primary use for the reversible cleaning device is to clean a soiled area on the surface on a house pet.

In operation, the user places his or her hand inside the access opening of the cleaning device and wipes a soiled surface with the wet towel layer. The padded surface of the outer wet towel layer absorbs moisture and cleans and/or disinfects the soiled surface. The user may then then turn the cleaning device inside out, as shown in FIG. 1B, so as to expose the dry layer of the cleaning device. The user can then wipe a wet, disinfectant area dry, with the dry layer of the cleaning device.

### BRIEF DESCRIPTION OF THE DRAWINGS

FIG. 1A is a schematic view of the reversible, wet and dry cleaning device with the user's hand inside the cleaning device.

FIG. 1B is a schematic view of the reversible, wet and dry cleaning device. After using the cleaning device the user may pull the cleaning device inside out to expose the dry side of the cleaning device for use. See the directional arrows in FIG. 1B.

FIG. 2A is a schematic view of the reversible, wet and dry cleaning device which can be dispensed through a rolling method.

FIG. 2B is a schematic view of the reversible, wet and dry cleaning device which can be dispensed through a tear open method.

FIG. 3 is a schematic view of various layers of the reversible, wet and dry cleaning device. These include the wet outside layer and the dry/inner layer.

FIG. 4A is a schematic view of a rectangle shaped reversible, wet and dry cleaning device.

FIG. 4B is a schematic view of a round shaped reversible, wet and dry cleaning device.

FIG. 4C is a schematic view of a round and tapered reversible, wet and dry cleaning device.

### DETAILED DESCRIPTION OF THE INVENTION

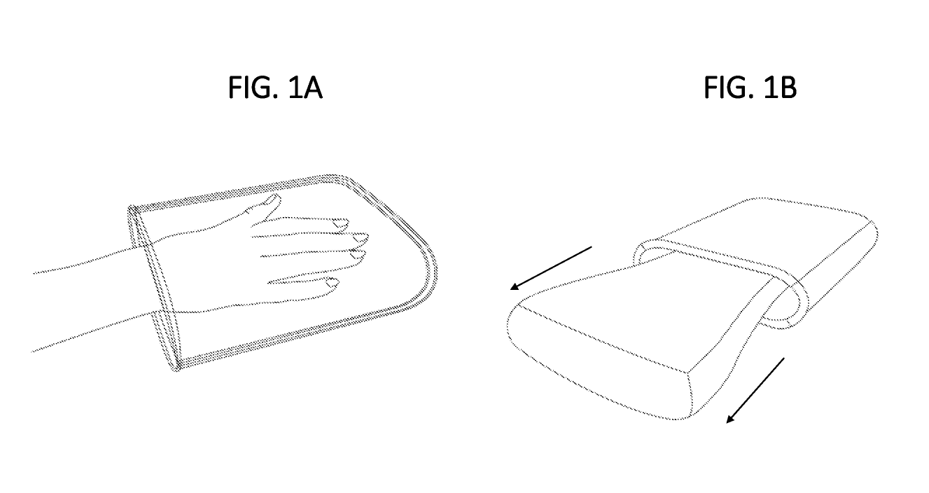

Referring particularly to the drawing shown in FIG. 1A, the reversible, wet and dry cleaning device is composed primarily of an outer wet towel layer and a reversible inner dry towel layer. The outer wet towel layer and inner dry towel layer are separated by a plastic layer. The cleaning device is primarily used for facilitate the cleaning of house pets after outdoor play.

Preferably, the cleaning device is sized and shaped to receive an adult's hand, FIG. 1A, and may be used by either left handed or right handed individuals. In the preferred embodiment, the cleaning device is constructed of biodegradable or environmentally friendly materials, but those skilled in the art will recognize that other materials may be used.

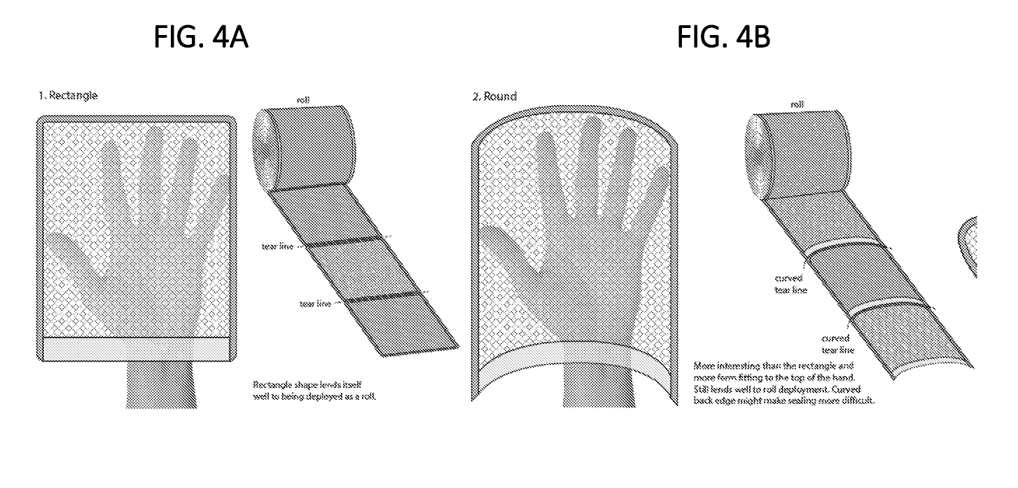

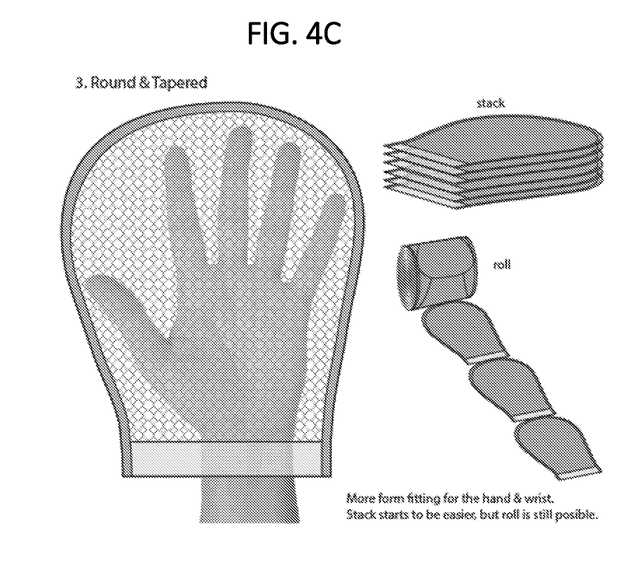

The preferred embodiment of the cleaning device is generally rectangular in shape, as shown in FIG. 4A, but may be constructed with round and round and tapered dimensions, as shown in FIG. 4B and FIG. 4C, respectively. The rectangular shape lends itself well to being deployed as a roll. The round shape may is more form fitting to the top of a user's hand. The round and tapered shape is even more form fitting for the hand and wrist and may be dispensed as a stack instead of a roll.

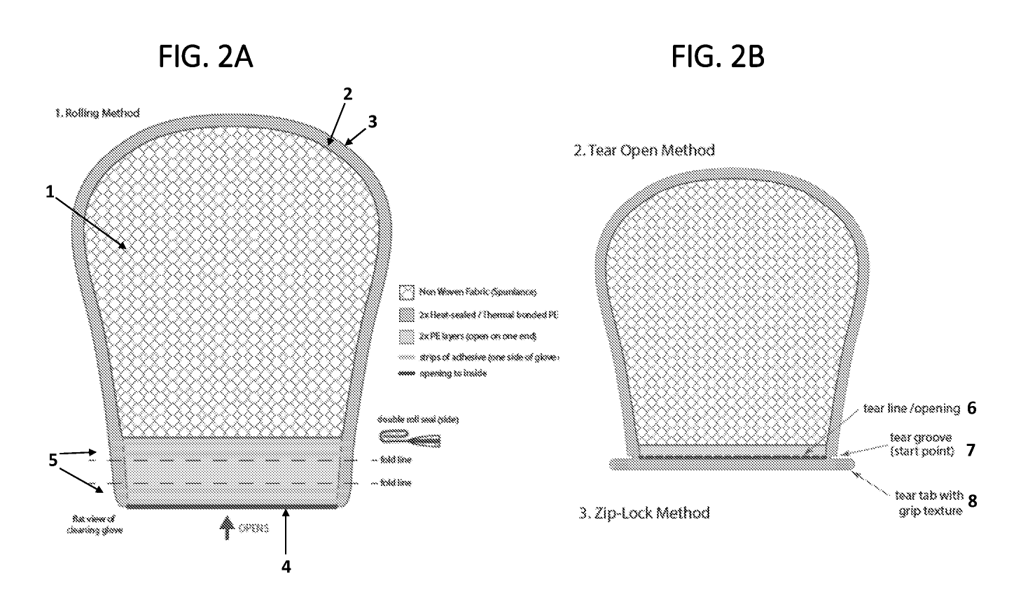

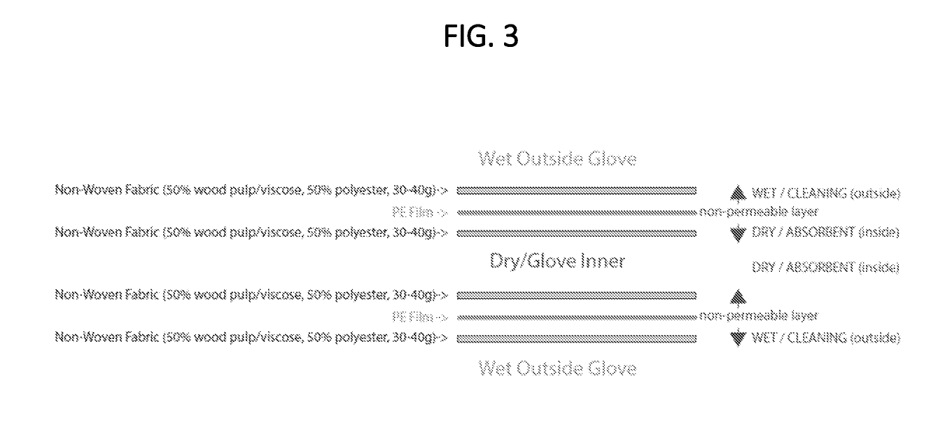

Referring to the preferred embodiment in the drawing shown in FIG. 2A, the reversible, wet and dry cleaning device consists of a wet outer towel layer and an dry inner towel layer made of a non-woven fabric 1 separated by a polyethylene (PE) layer/film, as shown in FIG. 3. On the outer edge of the wet and dry cleaning device, 2 and 3, two (2) layers of PE are thermally bonded and/or heat sealed. The cleaning device opens on the bottom end, 4, and strips of adhesive 5, and present above and below the two (2) fold lines to facilitate a double roll seal for packaging purposes.

In another embodiment, the cleaning device possesses a tear open design, as shown in FIG. 2B, wherein there is a tear line/opening, 6, with a tear groove start point, 7, and a tear tab with a grip texture, 8, to facilitate the opening of the bottom end so the user may insert their hand into the dry end.

After the user has wiped the soiled surface with the outer wet towel layer, the cleaning device can be turned inside out, as shown in FIG. 1B, exposing the dry layer of the cleaning device. The versatility of a wet and dry side of the cleaning device separated by a plastic barrier allow a user to wipe a wet disinfected area with a dry towel layer.

Although the invention has been described with respect to specific embodiments and configurations, those of skill in the art will recognize that many modifications may be made thereto.

What is claimed is:

1. A reversible cleaning device for cleaning a soiled area wherein the reversible cleaning device comprises a wet outer towel layer and a dry inner towel layer separated by a plastic barrier layer.

2. The reversible cleaning device as defined in claim 1, wherein the wet outer towel layer, the dry inner towel layer, and plastic barrier layer are thermally bonded to each other.

3. The reversible cleaning device of claim 2, wherein the reversible cleaning device includes an access opening for a user's hand at the bottom end of said reversible cleaning device.

4. The reversible cleaning device of claim 3, wherein the reversible cleaning device is used to clean a soiled area on the surface of a house pet.
